(19) United States
(12) Patent Application Publication
(10) Pub. No.: US 2008/0205730 A1
(43) Pub. Date: Aug. 28, 2008

(54) Independent Motion Correction In Respective Signal Channels Of A Magnetic Resonance Imaging System

(75) Inventors: Christian Stehning, Hamburg (DE); Kay Nehrke, Ammersbek (DE); Peter Boernert, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 11/913,479

(22) PCT Filed: Apr. 26, 2006
(86) PCT No.: PCT/IB06/51297

§ 371 Date: Nov. 2, 2007

(30) Foreign Application Priority Data
May 2, 2005 (EP) 05103637.4

(51) Int. Cl. G06K 9/00

(52) U.S. Cl. 382/131

(57) ABSTRACT

A magnetic resonance imaging (MRI) system, wherein a plurality of independent signal acquisition channels, defined by spatially separated coil elements (14a, 14b, 14c, 14d, 14e, 14f) is provided. The signals received by each of the channels are individually motion corrected before image reconstruction, so that non-uniform, non-affine motion across the imaging volume can be corrected locally. Motion correction may be prospective or retrospective.

The invention relates generally to nuclear magnetic resonance imaging methods and systems and, more particularly, to methods for acquiring magnetic resonance imaging (MRI) data using a multi-channel magnetic resonance (MR) system in which several independent signal acquisition channels are employed.

Magnetic resonance Imaging (MRI) is a widely used technique for medical diagnostic imaging. In a conventional MRI scanner, a patient is placed in an intense static magnetic field which results in the alignement of the magnetic moments of nuclei with non zero spin quantum numbers either parallel or anti-parallel to the field direction. Boltzmann distribution of moments between the two orientations results in a net magnetisation along the field direction. This magnetisation may be manipulated by applying a radio frequency (RF) magnetic field at a frequency determined by the nuclear species under study (usually hydrogen atoms present in the body, primarily in water molecules) and the strength of the applied field. The energy absorbed by nuclei from the RF field is subsequently re-emitted and may be detected as an oscillating electrical voltage, or free induction decay signal, in an appropriately tuned antenna and image processing means are employed to reconstruct an image, which image is based on the location and strength of the incoming signals.

When utilising these signals to produce images, magnetic field gradients Gₓ, G_{y} and G_{z} are employed. Typically, the region to be imaged is scanned by a sequence of measurement cycles in which these gradients vary according to the particular localisation method being used. The resulting series of views that is acquired during the scan form a nuclear magnetic resonance (NMR) image data set from which an image can be reconstructed using one of many well known reconstruction techniques. However, the acquisition of each view requires a finite amount of time, and the more views that are required to obtain an image of the prescribed field of view and spatial resolution, the longer the total scan time.

In recent NMR systems, multiple coils (i.e. multiple independent signal acquisition channels) are employed. These measures are beneficial for several reasons, for example, an improved signal-to-noise ratio (SNR), or the reduction of scan time by means of parallel imaging approaches such as sensitivity encoding (SENSE).

However, patient movement during the acquisition of MRI generally results in degradation of the images that can obscure the clinically relevant information. Movement leads to phase errors or misaligned lines in k-space which, in the resulting image, appear as image artefacts, such as blurring and ghosting. Translation movement results in phase errors, while rotational movement, expansion, contraction or shearing of the imaged object result in misaligned k-space lines.

Various techniques have been employed to correct for image artefacts introduced into an image through motion. However, while conventional approaches already cover a wide range of motion patterns including fully affine motion (translation, expansion, rotation, shearing), they tend to be inherently limited to the correction of global motion that follows a uniform model over the whole body. If parts of the imaged volume are static or undergo a different motion pattern, the mismatch of the applied motion correction will result in blurring and ghosting or streaking artefacts across the entire image.

Other techniques known for correcting for patient motion involve a modified signal acquisition technique which may involve additional scans or even additional equipment. For example, US Patent Application Publication No. US 2003/0052676 A1 describes an MRI system in which the spatial sensitivity profile of each RF coil in a parallel imaging arrangement, such as that described above, is determined from the MR image data acquired thereby so as to avoid any mismatch between the acquired sensitivity profiles and the acquired image data caused by patient motion.

It is an object of the present invention to provide a magnetic resonance imaging system having several independent signal acquisition channels, in which non-uniform motion occurring at different parts of a subject can be corrected for independently, without a significant increase in data acquisition time or additional hardware. It is also an object of the present invention to provide a corresponding method of magnetic resonance imaging, a computer-implemented image processing method for use in a magnetic resonance imaging system, and a computer program for performing such an image processing method.

In accordance with the present invention, there is provided a magnetic resonance imaging system for generating one or more images of a body volume of a subject, the system comprising means for generating a static magnetic field within which said subject can be positioned, means for applying a radio frequency magnetic field to said subject, antenna means for detecting radio frequency energy absorbed by nuclei within said body volume and subsequently re-emitted (during a scanning or MR data acquisition process), and image processing means for constructing an image of said body volume based on the location and strength of said detected radio frequency energy, wherein the antenna means comprises a plurality of tuned antennas defining a plurality of respective independent signal acquisition channels for receiving image data representative of radio frequency energy re-emitted from different respective parts of said body volume, the system further comprising means for performing independent motion correction in respect of image data received by each of said signal acquisition channels.

Thus, the present invention allows for a correction of non-uniform motion across the imaging volume, by performing individual motion correction in respect of each signal acquisition channel. Each individual coil connected to a multi-channel system acquires data from a localised region close to the respective coil position only. Thus, local motion in the vicinity of the respective receive coil can be addressed by individual, coil-specific correction. In particular, complex, non-rigid or non-uniform motion patterns across the imaging volume can thus be decomposed into independent, local motion models with reduced complexity. Non-uniform, non-rigid motion across the imaging volume can thus be handled without any additional hardware and with negligible additional cost, compared with prior art systems.

Overall, the present invention allows for a more precise motion correction when compared to other approaches, resulting in an increased image quality and decreased scan times for improved patient throughput.

In a preferred embodiment, the image data received by each of said independent signal acquisition channels is independently digitised by a respective analogue-to-digital converter. The independent motion correction performed in respect of the image data received by each of said independent signal acquisition channels may comprise prospective (i.e. during MR data acquisition) or retrospective (i.e. after MR data acquisition) motion correction. In a first exemplary embodiment, each independent signal acquisition channel associated with a specific antenna is supplied with a respective individual demodulation frequency Δf and phase Δφ as a function of a local motion state (and, therefore, as a function of time), which is determined by the object translation d_{OBJ} that is compensated for according to the following equations:

$$\begin{matrix}Δ f = γ \cdot {G}_{R} \cdot {d}_{OBJ} \cdot cos ( ϑ ) \\ Δ φ = γ \cdot {d}_{OBJ} \cdot cos ( ϕ ) \cdot {\int }_{0}^{T} {G}_{PE} d t\end{matrix}$$

where γ denotes the gyromagnetic ratio, G_{R} and G_{PE} are the readout- and phase encoding gradients, respectively, and [symbol] and φ are the angles between the respective gradients and the motion direction. In general, in respect of each coil, a different Δf and Δφ will be chosen for correction.

The coil-specific correction may be achieved by the provision of individually tunable demodulation hardware modules in respect of each of the respective channels, or it may be implemented by means of digital signal processing techniques applied after digitisation of the image data. Global motion correction may additionally be performed in respect of image data received by all of the signal acquisition channels.

In an alternative exemplary embodiment, retrospective motion correction may be performed individually in respect of the MR data received by each of said independent signal acquisition channels, by accounting for phase errors and misalignment of k-space lines in the image reconstruction process, for instance by regridding said respective MR data in k-space prior to image reconstruction as described in J D O'Sullivan, “A Fast Sinc Function Grodding Algorithm for Fourier Inversion in Computer Tomography”, IEEE Trans. Med. Imaging MI-4, 200-207 (1985).

Also in accordance with the present invention, there is provided a method of magnetic resonance imaging for generating one or more images of a body volume of a subject, the method comprising generating a static magnetic field within which said subject can be positioned, applying a radio frequency magnetic field to said subject, detecting radio frequency energy absorbed by nuclei within said body volume and subsequently re-emitted (during an MR data acquisition or scanning process), reconstructing an image of said body volume based on the location and strength of said detected radio frequency energy, wherein said step of detecting re-emitted radio frequency energy comprises the use of a plurality of tuned antennas defining a plurality of respective independent signal acquisition channels for receiving image data representative of radio frequency energy re-emitted from different respective parts of said body volume, the method further comprising the step of performing independent motion correction in respect of image data received by each of said signal acquisition channels.

Beneficially, the method may comprise the further step of measuring a subject-specific global model prior to said scanning process and decomposing said global motion model into a plurality of local motion models. Such local motion models may feature reduced complexity relative to the global model.

The present invention extends to a computer-implemented image processing method for use in a magnetic resonance imaging system as defined above, the method comprising the steps of receiving image data from each of the plurality of independent signal acquisition channel, performing individual motion correction in respect of image data received from each signal acquisition channel, and reconstructing an image of said body volume using said image data.

The motion correction may be prospective or retrospective. In the case where motion correction is prospective (i.e. during MR data acquisition), the method beneficially comprises the step of supplying an individual demodulation frequency and phase to each respective signal acquisition channel. In the case where the motion correction is retrospective (i.e. after MR data acquisition), the method beneficially comprises the step of re-gridding the image data received by each respective signal acquisition channel prior to image reconstruction.

The present invention extends still further to a computer program for performing an image processing method for use in the magnetic resonance imaging system as defined above, comprising software code for performing individual motion connection in respect of image data received from each signal acquisition channel and reconstructing an image of said body volume using said image data.

These and other aspects of the present invention will be apparent from, and elucidated with reference to the embodiments described herein.

Embodiments of the present invention will now be described by way of examples only and with reference to the accompanying drawings, in which:

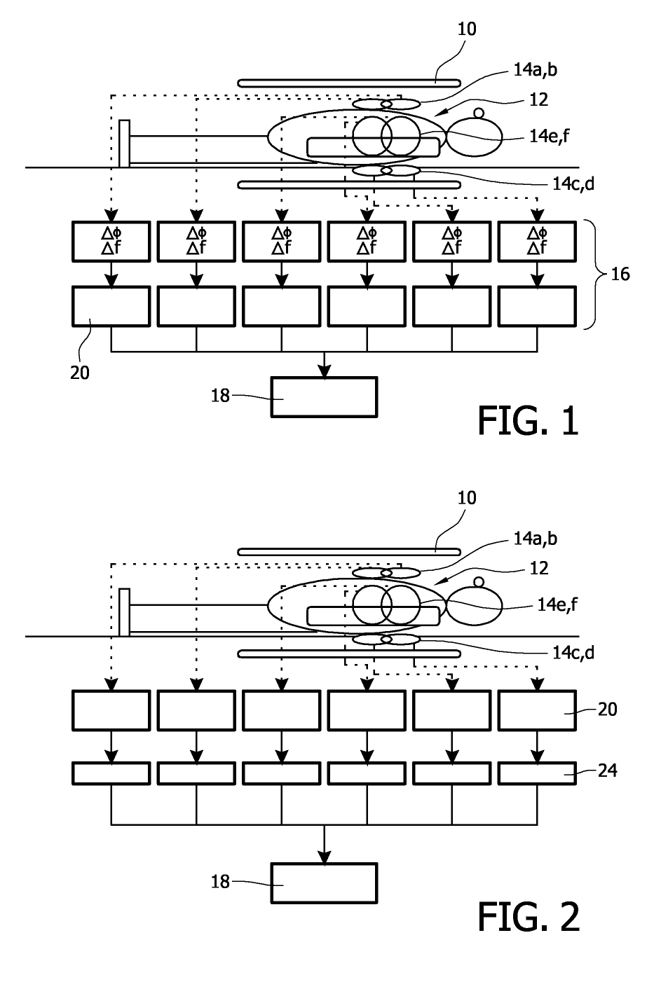

FIG. 1 is a schematic block diagram illustrating a magnetic resonance imaging (MRI) system according to a first exemplary embodiment of the present invention, with individual demodulation frequency and phase for prospective translational motion correction during scanning; and

FIG. 2 is a schematic block digram illustrating a magnet resonance imaging (MRI) system according to a second exemplary embodiment of the present invention, for coil-specific motion correction with retrospective, fully affine correction.

For the sake of clarity, the current state of the art will first be described, where it is relevant to the present invention. In magnetic resonance (MR) imaging, motion is a major source of image artifacts. Various known approaches are used to cope with different types of motion (respiration, cardiac motion) that may occur during MR examinations. Using a triggered or gated acquisition, motion is “frozen” by confining data acquisition to short temporal frames with equal motion states, e.g. the cardiac rest period in late diastole, or a stable position in end-expiration. One particular drawback of this approach is a significant increase in scan time, as the scan efficiency, or the amount of MR data acquired per time unit, is decreased. For instance, in cardiac imaging, less than 10% of the cardiac cycle (end-diastolic rest period) are used for data acquisition. In addition, 50% (approx) of the acquired data is rejected due to respiratory gating, resulting in an overall scan efficiency of less than 5%. As a consequence thereof, scan times are increased to the order of several minutes, which may not be tolerated by patients in clinical practice.

As a more advanced approach to maintain a short scan time, rigid-body or affine motion correction can be applied. This technique entails an adaption of the imaged volume to the momentary motion state, e.g. slice tracking for respiratory motion. This approach provides improved scan efficiency when compared to pure triggering or gating. However, this technique is currently limited to the correction of rigid-body or affine motion that is uniform over the entire imaged region (“global motion”). If parts of the imaged volume are static, or undergo a different motion pattern, the mismatch between the assumed motion model and actual motion will result in blurring and ghosting or streaking artifacts over the reconstructed image. This is a common obstacle in cardiac MR imaging, where the respiration-induced motion of the heart is compensated for, but other regions in the body that are static or undergo a different motion, e.g. the anterior chest wall, introduce blurring as a result of the locally incorrect motion compensation. However, with the development of multi-channel systems and multi-coil arrays for signal reception, it becomes possible to assign a localized imaging region to every coil. Thus, the data acquired with each coil can, to a certain extent, be motion-corrected individually. This makes it possible to cope with complex or non-uniform motion across the entire imaged volume, which is subdivided into simplified motion models for the imaged region of each coil. This approach could be used to cope with global non-rigid motion, which cannot be handled with conventional motion correction techniques unless costly higher order gradient systems are employed.

According to the current state-of-the-art, three principle approaches relating to motion correction are known:
(1) Triggered or gated acquisition. This straightforward motion compensation method freezes motion by confining data acquisition to short temporal frames with equal motion states, e.g. the cardiac rest period in late diastole, or a stable position in end-expiration. This approach is commonly applied to cope with intrinsic cardiac motion. Due to the low scan efficiency, the scan time is generally increased by a large scale.
(2) Prospective motion correction (during MR data acquisition). In this approach, the data acquisition is modified in real-time to adapt imaging to the momentary motion state. For instance, this technique is applied in cardiac MRI to cope with respiratory motion, i.e. the imaging slide is moved in foot-head direction with the respiration-induced motion of the heart. Advanced approaches include an affine correction that copes with rotation, expansion and shearing motion. However, all these approaches are limited to the correction of global motion, i.e. the entire imaged region following the same motion pattern.
(3) Retrospective motion correction(after MR data acquisition):
(a) In k-space: In this (non-realtime) approach, the acquired k-space data is motion corrected after sampling, but prior to image reconstruction. Recent approaches also make use of the additional information contained in the multi-coil data to estimate and correct for motion. However, the restriction to the correction of globalmotion as described in (2) applies here as well.
(b) In image space: In this approach, motion is corrected after image reconstruction. This approach is not confined to global motion or a specified motion model. However, this technique needs an entire time-series of the object to be acquired, which may require vast oversampling.

However, one particular asset of both retrospective techniques is that only motion that occurs within the imaged volume can be corrected retrospectively. If the object, or parts thereof, leave the imaged volume due to motion, no retrospective correction is possible.

In accordance with the invention, a coil-specific motion correction of data acquired on a multi-channel magnetic resonance (MR) system is proposed, with the primary purpose of the proposed approach being to cope with non-rigid motion or motion that is not uniform over the entire imaging volume. Accordingly, it is proposed to perform individual motion correction for the data acquired with each coil element of a multi-channel magnetic resonance (MR) system. In principle, at least two approaches may be employed to achieve the object of the invention.

Referring to FIG. 1 of the drawings, a typical multi-channel magnetic resonance imaging (MRI) system comprises a large, cylinder-shaped magnet 10 in which a patient 12 lies. A plurality of RF coils 14 are provided within the cylindrical magnet 10 to receive the NMR signals that are produced during the MRI scan. Two coil elements 14a, b are positioned anterior to the imaging volume and two coil elements 14c, d are positioned posterior thereto. A third pair of coil elements 14e, f is provided at the side of the imaging volume. Together, the coils 14a, b, c, d, e and f form a local coil array, and it will be appreciated by a person skilled in the art that the present invention is not limited to any particular local coil array and that many alternative local coils are commercially available and suitable for this purpose.

The NMR signals picked up by the coil elements 14a, b, c, d, e, f are digitised by a transceiver module 16 and transferred to an image reconstruction module 18. When the image scan is completed, the six resulting k-space data sets are processed to reconstruct images of the body volume. This reconstruction tends to be a two- or three-dimensional, complex Fourier transformation which yields an array of complex pixel intensity values for each slice acquired by each local coil element, as will be known to a person skilled in the art.

The transceiver module 16 comprises a set of analogue to digital converters 20, one for each respective coil element 14a, b, c, d, e, f, each analogue-to-digital converter 20 receiving an input signal from a respective coil element. In a first exemplary embodiment of the present invention, during data acquisition, each hardware receive channel (defined by respective coil elements) is supplied with an individual demodulation frequency Δf and phase Δφ, as indicated by the modules 22 in FIG. 1 of the drawings. This may be implemented in terms of separate demodulation hardware for each receive channel (as shown in FIG. 1), or it may be based on digital signal processing after analogue-to-digital conversion of the acquired data (as will be described in more detail later with reference to FIG. 2).

Referring back to FIG. 1 of the drawings, the provision of individually tunable demodulation frequency and phase modules 22 allow for an individual shift of the acquired echoes to cope with translational motion along the readout and phase encoding direction during scanning, and facilitates the correction of in-plane translational motion (2D scans), or a correction of translation in all three spatial dimensions if a 3D scan is performed. This type of motion correction is known as prospective (during MR data acquisition) correction, for instance by means of employing a predefined motion model, and will be familiar to a person skilled in the art. Furthermore, this type of coil-specific motion correction can be applied in combination with a known technique for prospective correction of affine motion, such as BACCHUS (Breathing-Artifact Correction for Cardiac High-Resolution Imaging Using Patient-Specific Motion Models) which is a relatively new technique for advanced prospective respiratory motion correction employing a patient-specific respiratory model and multiple spatial and temporal navigators, whereby the navigators steer the affine motion model. More specifically, uniform rigid body motion (rotation, translation scaling, shearing) across the entire imaging region can be corrected globally using, for example, the BACCHUS technique, whereas residual local, translational motion that does not match the global motion model is corrected individually for each coil element.

In summary, therefore, in a first exemplary embodiment of the present invention, a patient-specific motion model may be measured in a pre-scan prior to the image acquisition and, in the case of respiratory motion, related to the respective position of the diaphragm (e.g. the BACCHUS approach). By this means, the predetermined global motion model may be decomposed into a plurality of local motion models, which may feature reduced complexity. For individual prospective motion correction for the the area near each individual coil element, each receive channel of the MR system may be supplied with an individually tunable demodulation frequency and phase by, for example, providing an individual mixer for each channel. For a software-based implementation, the acquired k-space data can be modulated after analogue-to-digital conversion. Furthermore, the correction may equally be performed retrospectively after acquisition of MR data.

In an alternative exemplary embodiment of the present invention, retrospective correction may be employed in respect of each receive channel of the MR system after MR data acquisition. In this case, a correction of more complex models such as translation, rotation expansion and shearing of the scanned data can be performed individually for each coil element 14a, b, c, d, e, f, for instance by re-gridding (cf regridding modules 24) the data in k-space prior to reconstruction, as illustrated in FIG. 2 of the drawings. For retrospective motion correction, no additional hardware is necessary. One possible embodiment may employ a 3D-radial whole heart protocol with retrospective, self-navigated motion correction, as described by Stehning C, Nehrke K, Bomert P, Eggers H, Stuber M in “Free-breathing whole-heart MRI with 3D-radial SSFP and self-navigated image reconstruction, 8^{th} annual scientific meeting SCMR, San Francisco, 2005. The respiration-induced bulk cardiac motion is extracted from the ID-Fourier transform of the first echo acquired in each cardiac cycle, hereinafter referred to as the “navigator profile”. It is acquired in the patient's foot-head direction, where respiratory motion is extracted from this profile using a center-of-mass approach, as described in the above-mentioned reference, and the data acquired in each corresponding cardiac cycle is motion-corrected using the Fourier-shift theorem. With regard to this approach, it is relatively straightforward to perform an individual correction for the data acquired with each coil. Fast reconstruction hardware and algorithms can be employed to cope with the increased computational effort during image reconstruction.

Regardless of the technique used for motion correction, a classification of the individual motion parameters for each coil element is necessary. For this purpose, possible techniques include:
1) Patient-specific registration of motion in a pre-scan (model-based correction), whereby motion can be registered in a pre-scan prior to the actual image acquisition for each individual coil region (using, for example, the above-mentioned BACCHUS technology); and
2) Detection of motion directly from acquired MR data (image data-based correction) whereby, if a retrospective correction method is applied motion can be extracted directly from the echoes used for image reconstruction (see the above-mentioned reference by Stehning et al), and no additional pre-scan is necessary.

It is thus an object of the present invention to facilitate a correction (prospective or retrospective) of motion that is not uniform over the whole imaging region. This enables non-rigid, non-uniform types of motion to be handled, that cannot currently be compensated for, and enables artefacts resulting from imprecise motion correction using known methods to be reduced. This potentially increases image quality and scan efficiency for different types of MR acquisition. Scan times are reduced and patient throughput is increased. The present invention is applicable to any and all kinds of MR acquisition that requires motion correction.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1-12. (canceled)

13. A magnetic resonance imaging system for generating one or more images of a body volume of a subject, the system comprising means for generating a static magnetic field within which said subject can be positioned, means for applying a radio frequency magnetic field to said subject, antenna means for detecting radio frequency energy absorbed by nuclei within said body volume and subsequently re-emitted during a scanning process, and image processing means for reconstructing an image of said body volume based on the location and strength of said detected radio frequency energy, wherein the antenna means comprises a plurality of tuned antennas defining a plurality of respective independent signal acquisition channels for receiving image data representative of radio frequency energy re-emitted from different respective parts of said body volume, the system further comprising means for receiving or determining individual motion parameters in respect of image data received by each of said signal acquisition channels and subsequently performing independent motion correction in respect of image data received by each of said signal acquisition channels using respective said individual motion parameters.

14. A system according to claim 13, wherein said individual motion parameters are obtained by measuring a subject-specific global motion model prior to said scanning process and decomposing said global motion model into a plurality of local motion models.

15. A system according to claim 13, wherein said individual motion parameters are extracted during said scanning process.

16. A system according to claim 13, wherein said independent motion correction performed in respect of the image data received by each of said independent signal acquisition channels comprises prospective motion correction.

17. A system according to claim 13, wherein each independent signal acquisition channel associated with a specific antenna is supplied with a respective individual demodulation frequency and phase as a function of a local motion state.

18. A system according to claim 17, comprising an individually tunable demodulation module in respect of each of the respective channels.

19. A system according to claim 17, wherein each independent signal acquisition channel is supplied with an individual demodulation frequency and phase by means of a digital signal processing technique applied after digitization of the image data.

20. A system according to claim 1 3, wherein global motion correction is additionally performed in respect of image data received by all of the signal acquisition channels.

21. A system according to claim 13, wherein said independent motion correction performed in respect of image data received by each of said independent signal acquisition channels, comprises retrospective motion correction.

22. A system according to claim 21, wherein said retrospective motion correction is performed individually in respect of the image data received by each of said independent signal acquisition channels, by re-gridding said respective image data in k-space prior to image reconstruction.

23. A method of magnetic resonance imaging for generating one or more images of a body volume of a subject, the method comprising generating a static magnetic field within which said subject can be positioned, applying a radio frequency magnetic field to said subject, detecting radio frequency energy absorbed by nuclei within said body volume and subsequently re-emitted during a scanning process, reconstructing an image of said body volume based on the location and strength of said detected radio frequency energy, wherein said step of detecting re-emitted radio frequency energy comprises the use of a plurality of tuned antennas defining a plurality of respective independent signal acquisition channels for receiving image data representative of radio frequency energy re-emitted from different respective parts of said body volume, the method further comprising the steps of receiving or determining individual motion parameters in respect of image data received by each of said signal acquisition channels and subsequently performing independent motion correction in respect of image data received by each of said signal acquisition channels using respective said individual motion parameters.

24. A method according to claim 23, comprising the further step of measuring a subject-specific global motion model prior to said scanning process and decomposing said global motion model into a plurality of local motion models.

25. A method according to claim 23, wherein said individual motion parameters are extracted during said scanning process.

26. A computer-implemented image processing method for use in a magnetic resonance imaging system according to claim 13, the method comprising the steps of receiving image data from each of the plurality of independent signal acquisition channels, receiving or determining individual motion parameters in respect of image data received from each of said signal acquisition channels, subsequently performing individual motion correction in respect of image data received from each signal acquisition channel using a respective said individual motion parameter, and reconstructing an image of said body volume using said image data.

27. A computer program for performing an image processing method for use in a magnetic resonance imaging system according to claim 13, comprising software code receiving or determining individual motion parameters in respect of image data received by each of said signal acquisition channels and subsequently performing individual motion correction in respect of image data received from each signal acquisition channel using a respective said individual motion parameter, and reconstructing an image of said body volume using said image data.
